(19) United States
(12) Patent Application Publication
(10) Pub. No.: US 2022/0345927 A1
(43) Pub. Date: Oct. 27, 2022

(54) PROPAGATION CHARACTERISTIC MEASURING SYSTEM AND PROPAGATION CHARACTERISTIC MEASURING METHOD

(71) Applicant: NIPPON TELEGRAPH AND TELEPHONE CORPORATION, Tokyo (JP)

(72) Inventors: Nobuaki KUNO, Musashino-shi, Tokyo (JP); Wataru YAMADA, Musashino-shi, Tokyo (JP); Mitsuki NAKAMURA, Musashino-shi, Tokyo (JP); Takatsune MORIYAMA, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 17/765,142

(22) PCT Filed: Oct. 4, 2019
(86) PCT No.: PCT/JP2019/039354

§ 371 Date: Mar. 30, 2022

(51) Int. Cl. H04W 24/10; H04W 56/00

(52) U.S. Cl. CPC H04W 24/10; H04W 56/001; H04W 84/06

(57) ABSTRACT

Provided are: a first wireless station, a second wireless station that can move to an arbitrary position in a three-dimensional space and perform wireless communication with the first wireless station, and a measuring device that measures the position of the second wireless station in the three-dimensional space to obtain measurement information. At least one out of the first wireless station, the second wireless station, and the measuring device includes: an acquisition unit that acquires reception signal information that was received by the first wireless station or the second wireless station, and a calculation unit that associates the measurement information and the reception signal information with each other and calculates the propagation characteristics between the first wireless station and the second wireless station.

### TECHNICAL FIELD

The present invention relates to a propagation characteristic measurement system and a propagation characteristic measurement method.

### BACKGROUND ART

Conventionally, when measuring the propagation characteristics of radio waves, if the height of a transmitting antenna or a receiving antenna varies, measurement is performed by methods such as the following.

For example, there is a method of using an aerial work platform to change the antenna height when measuring the propagation characteristics of radio waves. In this case, the height of the antenna is based on the height of the aerial work platform.

There is also a method of using an unmanned aerial vehicle (e.g., a drone) to change the antenna height when. measuring the propagation characteristics of radio waves (see NPL 1). In this case, the height of the antenna is based on the height of the unmanned aerial vehicle. Altitude information that indicates the height of the unmanned aerial vehicle is calculated using a GPS antenna or a barometric pressure sensor that is provided in the unmanned aerial vehicle.

### CITATION LIST

### Patent Literature

[PTL 1] JP 2014-158110A

### Non Patent Literature

[NPL 1] M. Sasaki and 3 others, “Antenna Height Dependency of Clutter Loss for an Isolated Building by Measurement in Multi-Frequency Bands using a Drone”, IEICE, AP2018-18 (May 2018), p.29-33.

### SUMMARY OF THE INVENTION

### Technical Problem

However, in the case where the height of the antenna is changed using an aerial work platform, if the position of the antenna also varies, it is necessary to move the aerial work platform itself, and therefore the measurement of propagation characteristics is time-consuming. Furthermore, propagation characteristics cannot be measured in an environment such as an indoor environment that an aerial work platform cannot enter.

Also, in the case where the antenna height is changed using an unmanned aerial vehicle, it is easy to change the position of the antenna, and the time required for the measurement of propagation characteristics can be shortened. However, if the altitude information that indicates the height of the unmanned aerial vehicle is calculated using a GPS antenna or a barometric pressure sensor, the accuracy of the altitude information depends on the weather and the measurement environment.

An object of the present invention is to provide a propagation characteristic measurement system and a propagation characteristic measurement method that are capable of accurately and easily measuring the propagation characteristics of radio waves at an arbitrary position in a three-dimensional space.

### MEANS FOR SOLVING THE PROBLEM

A propagation characteristic measurement system according to an aspect of the present invention includes: a first wireless station; a second wireless station configured to be capable of moving to an arbitrary position in a three-dimensional space, and configured to perform wireless communication with the first wireless station; and a measuring device configured to measure a position of the second wireless station in the three-dimensional space to obtain measurement information, wherein at least one out of the first wireless station, the second wireless station, and the measuring device includes an acquisition unit configured to acquire reception signal information that was received by the first wireless station or the second wireless station, and a calculation unit configured to associate the measurement information and the reception signal information with each other and calculate a propagation characteristic between the first wireless station and the second wireless station.

Also, a propagation characteristic measurement method according to an aspect of the present invention is a propagation characteristic measurement method for measuring a propagation characteristic between a first wireless station and a second wireless station that can move to an arbitrary position in a three-dimensional space and performs wireless communication with the first wireless station, the propagation characteristic measurement method including: a measuring step of measuring a position of the second wireless station in the three-dimensional space to obtain measurement information; an acquiring step of acquiring reception signal information that was received by the first wireless station or the second wireless station; and a calculating step of associating the measurement information and the reception signal information with each other and calculating a propagation characteristic between the first wireless station and the second wireless station.

### EFFECTS OF THE INVENTION

According to the present invention, the propagation characteristics of radio waves can be accurately and easily measured at an arbitrary position in a three-dimensional space.

### BRIEF DESCRIPTION OF DRAWINGS

FIG. 1 is a diagram showing an example of a configuration of a propagation characteristic measurement system according to an embodiment.

FIG. 2 is a diagram showing an overview of functions of the propagation characteristic measurement system according to the embodiment.

FIG. 3 is a flowchart illustrating a procedure for measuring the propagation characteristics of wireless communication performed by a fixed station and a mobile station in the propagation characteristic measurement system.

FIG. 4 is a diagram showing a configuration of a modified example of the propagation characteristic measurement system.

### DESCRIPTION OF EMBODIMENTS

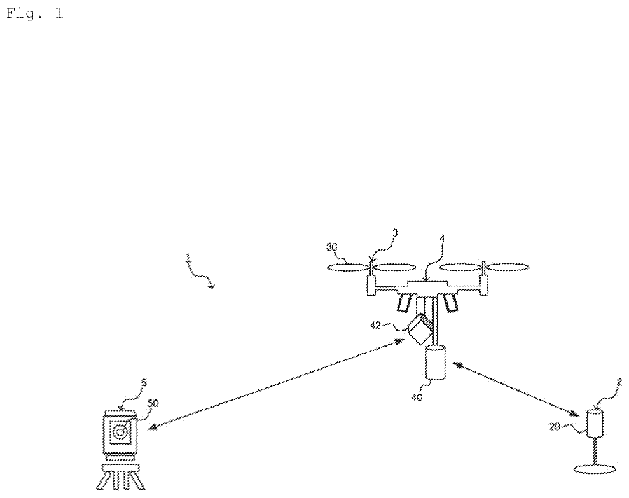

An embodiment of a propagation characteristic measurement system will be described below with reference to the drawings. FIG. 1 is a diagram showing an example of the configuration of a propagation characteristic measurement system 1 according to this embodiment. As shown in FIG. 1, the propagation characteristic measurement system 1 includes, for example, a fixed station (first wireless station) 2, a mobile station (second wireless station) 4 that is provided in an unmanned aerial vehicle 3, and a measuring device 5. The propagation characteristic measurement system 1 is a system that measures the propagation characteristics of wireless communication performed by the fixed station 2 and the mobile station 4.

In this following example of the configuration of the propagation characteristic measurement system 1, the fixed station 2 is the receiving station and the mobile station 4 is the transmitting station, but the configuration of the propagation characteristic measurement system 1 is not limited to this. For example, the fixed station 2 may be the transmitting station and the mobile station 4 may be the receiving station. Also, the fixed station 2, the unmanned aerial vehicle 3, the mobile station 4, and the measuring device 5 may each be provided with a CPU and a timer (not shown) for example, and may have the functionality of a computer.

The fixed station 2 has an antenna 20 for transmitting and receiving radio waves, and performs wireless communication with the mobile station 4.

As one example, the unmanned aerial vehicle 3 is a drone that has a plurality of propellers 30 and flies on a planned route in a three-dimensional space under wireless external control or under independent control in accordance with a program or the like.

The mobile station 4 is provided in the unmanned aerial vehicle 3 and moves together with the unmanned aerial vehicle 3 in the three-dimensional space. Also, the mobile station 4 has an antenna 40 for transmitting and receiving radio waves, and a prism 42 such as a corner cube reflector (retroreflector).

The antenna 40 transmits and receives radio waves to and from the antenna 20 of the fixed station 2. Note that the mobile station 4 has the antenna 40 at a position where the line of sight to the antenna 20 provided on the fixed station 2 is not obstructed. For example, if the antenna 20 of the fixed station 2 is provided on the ground, the antenna 40 is arranged in a lower portion of the unmanned aerial vehicle 3.

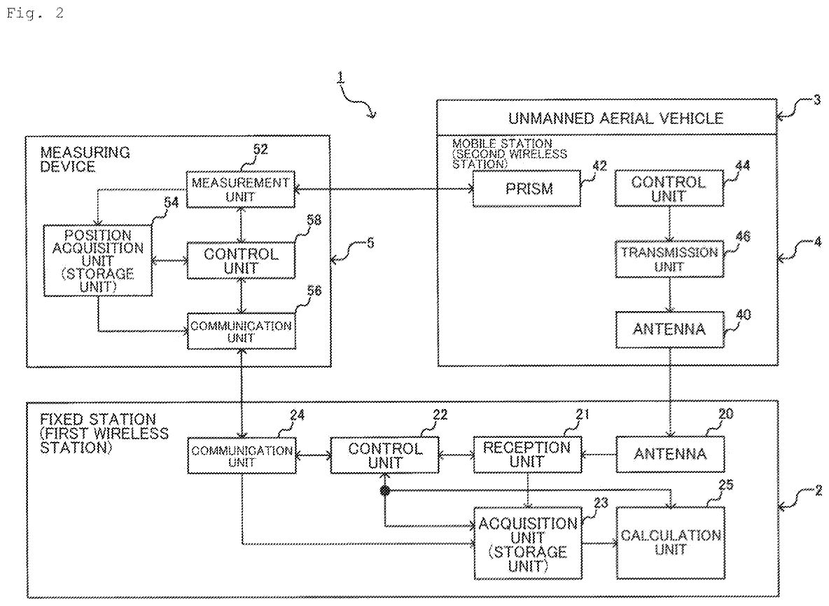

The prism 42 retroreflects the light emitted by the measuring device 5 (described later with reference to FIGS. 2 and the like) toward the measuring device 5

The measuring device 5 has a so-called automatic tracking function for .irradiating the prism 42 of the mobile station 4 with light via a lens 50 and automatically collimating the prism 42.

Next, the functions of the propagation characteristic measurement system 1 will be described. FIG. 2 is a diagram showing an overview of functions of the propagation characteristic measurement system 1. As described above, the propagation characteristic measurement system 1 includes the fixed station 2, the unmanned aerial vehicle 3, the mobile station 4, and the measuring device 5.

The mobile station 4 provided in the unmanned aerial vehicle 3 has the antenna 40, the prism 42, a control unit 44, and a transmission unit 46. Under control of the control unit 44, the transmission unit 46 transmits a transmission signal to the fixed station 2 via the antenna 40.

The measuring device 5 has a measurement unit 52, a position acquisition unit (storage unit) 54, a communication unit 56, and a control unit 58, and measures the position of the mobile station 4 in the three-dimensional space to obtain measurement information.

The measurement unit 52 includes the aforementioned lens 50, and measures the position of the prism 42 by irradiating the prism 42 with light and receiving the light retroreflected by the prism 42. For example, the measurement unit 52 measures the position of the mobile station 4 by measuring the vertical angle, the horizontal angle, the slope distance, and the like with respect to the mobile station 4 based on absolute coordinates assigned in advance.

The position acquisition unit 54 has the functionality of a storage unit such as a memory for acquiring and storing the position (measurement information) of the mobile station 4 measured by the measurement unit 52.

The communication unit 56 performs wireless communication or the like with the fixed station 2. For example, the communication unit 56 transmits the measurement information acquired by the position acquisition unit 54 to the fixed station 2. Also, the communication unit 56 exchanges time information with the measuring device 5 and the fixed station 2 in order to synchronize the time of the measuring device 5 and the fixed station 2.

The control unit 58 controls the units that constitute the measuring device 5. For example, the control unit 58 performs controls for automatically tracking the mobile station 4. Also, the control unit 58 synchronizes the time of the measuring device 5 and the fixed station 2 via the communication unit 56, and controls the timing of measurement performed by the measurement unit 52 and the timing of measurement information acquisition performed by the position acquisition unit 54.

The fixed station 2 has the antenna 20, a reception unit 21, a control unit 22, an acquisition unit (storage unit) 23, a communication unit 24, and a calculation unit 25.

The reception unit 21 receives the signal transmitted by the mobile station 4 via the antenna 20. The control unit 22 controls the units that constitute the fixed station 2. For example, the control unit 22 performs controls to synchronize the time when the measuring device 5 measures the position of the mobile station 4 and the time when the fixed station 2 receives a signal from the mobile station 4.

The acquisition unit 23 has the functionality of a storage unit such as a memory that acquires and stores a signal (reception signal information) and time information received by the reception unit 21. Also, the acquisition unit 23 acquires the position (measurement information) of the mobile station 4 measured by the measuring device 5 via the communication unit 24.

The communication unit 24 performs wireless communication with the measuring device 5, for example. For example, the communication unit 24 receives the measurement information measured by the measuring device 5 from the measuring device 5, and outputs the measurement information to the acquisition unit 23. Also, the communication unit 24 transmits and receives time information to and from the measuring device 5 and the fixed station 2 in order to synchronize the time of the measuring device 5 and the fixed station 2 under control of the control unit 22.

The calculation unit 25 acquires the measurement information and the reception signal information from the acquisition unit 23, associates the measurement information and the reception signal information with each other, and calculates the propagation characteristics between the fixed station 2 and the mobile station 4. Here, the calculation unit 25 associates the measurement information and the reception signal information with each other based on the time synchronized by the control unit 22.

Note that in the propagation characteristic measurement system 1, the functions provided in the fixed station 2, the mobile station 4, and the measuring device 5 are not limited to the configuration example shown in FIG. 2. For example, the fixed station 2 may function as a transmitting station, the mobile station 4 may function as a receiving station, and the mobile station 4 or the measuring device 5 may have the functions of the acquisition unit 23 and the calculation unit 25.

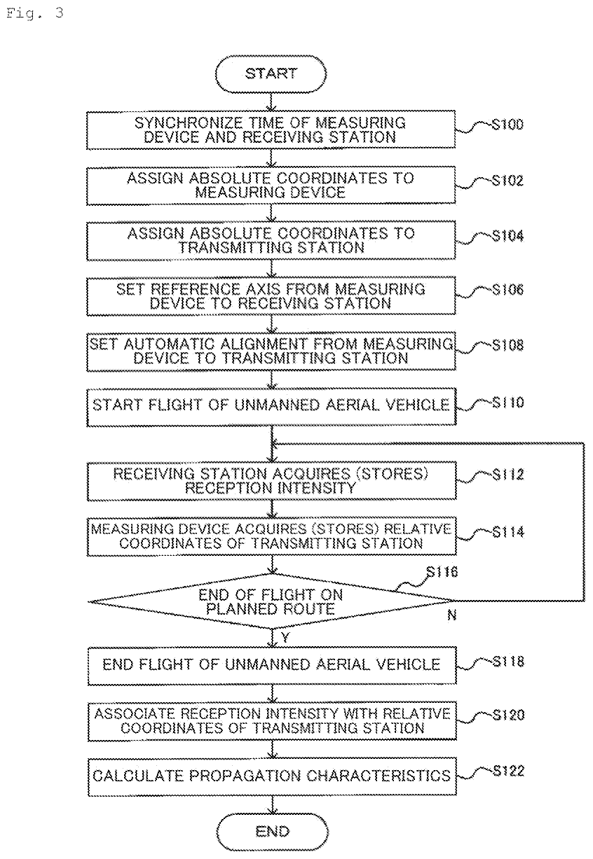

The following describes a procedure for measuring the propagation characteristics of wireless communication performed by the fixed station 2 and the mobile station 4 in the propagation characteristic measurement system 1. FIG. 3 is a flowchart illustrating a procedure for measuring the propagation characteristics of wireless communication performed by the fixed station 2 and the mobile station 4 in the propagation characteristic measurement system 1.

As shown in FIG. 3, the propagation characteristic measurement system 1 synchronizes the time of the measuring device 5 and the fixed station (receiving station) 2 (S100), for example.

A user assigns absolute coordinates to the measuring device 5 (S102) and also assigns absolute coordinates to the mobile station (transmitting station) 4 (S104).

The user then sets a reference axis from the measuring device 5 to the receiving station (S106), sets automatic alignment from the measuring device 5 to the transmitting station (S108), and starts the flight of the unmanned aerial vehicle 3 (S110).

The receiving station acquires (stores) the reception intensity (S112), and the measuring device 5 acquires (stores) the relative coordinates of the transmitting. station (S114).

The user determines whether or not the flight of the unmanned aerial vehicle 3 along the planned route has been completed (S116). If it is determined That flight on the planned route has not been completed (S116: No), the procedure returns to S112, and if it is determined that flight on the planned route has been completed (S116: Yes), the flight of the unmanned aerial vehicle 3 is ended (S118).

The receiving station associates the reception intensity and the relative coordinates of the transmitting station with each other (S120), and calculates the propagation characteristics (S122).

Note that the propagation characteristic measurement system 1 may measure the propagation characteristics of wireless communication in accordance with a user operation, or the propagation characteristics of wireless communication may be measured independently by a program that is included in at least any one of The fixed station 2, the unmanned aerial vehicle 3, the mobile station 4, and the measuring device 5.

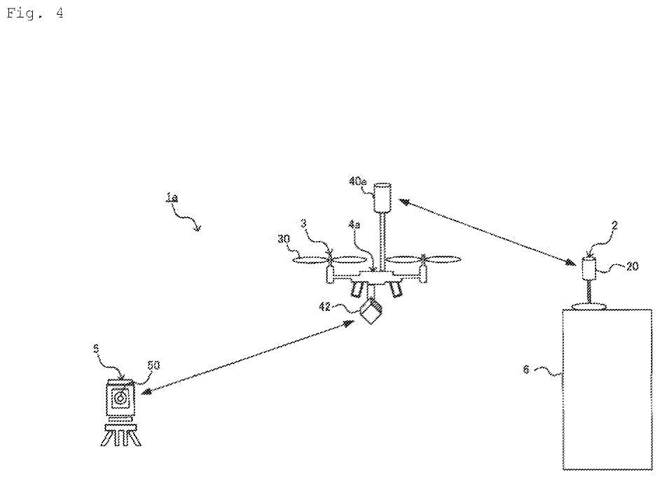

Next, a modified example of the propagation characteristic measurement system 1 will be described. FIG. 4 is a diagram showing the configuration of a modified example of the propagation characteristic measurement system 1 (propagation characteristic measurement system 1a).

As shown in FIG. 4, the propagation characteristic measurement system 1a includes the fixed station (first wireless station) 2, a mobile station (second wireless station) 4a provided in the unmanned aerial vehicle 3, and the measuring device 5, for example. Here, it is assumed that the fixed station 2 is disposed on the roof of a structure 6 such as a building. Note that in the propagation characteristic measurement system la shown in FIG. 4, configurations substantially the same as configurations of the propagation characteristic measurement system 1 shown in FIG. 1 are designated by the same reference numerals.

The mobile station 4a is provided in the unmanned aerial vehicle 3 and moves together with the unmanned aerial vehicle 3 in the three-dimensional space. Also, the mobile station 4a has an antenna 40a for transmitting and receiving radio waves, and the prism 42 such as a corner cube reflector (retroreflector).

The antenna 40a transmits and receives radio waves to and from the antenna 20 of the fixed station 2. Note that the mobile station 4a has the antenna 40a at a position where the line of sight to the antenna 20 provided on the fixed station 2 not obstructed by the propellers 30 and the like.

For example, if the antenna 20 of the fixed station 2 is disposed on the roof of the structure 6, the antenna 40a is located in an upper portion the unmanned aerial vehicle 3. This prevents the Generation of radio wave diffraction components and reflection components caused by the radio waves being obstructed by the propellers 30 or the like while the mobile station 4 ascends from the ground to the height of the structure 6

In this way, in the propagation characteristic measurement system 1 and the propagation characteristic measurement system 1a, measurement information. measured by the measuring device 5 for example and reception signal information received by the fixed station 2 are associated with each other, and the propagation characteristics between the fixed station 2 and the mobile station 4 are calculated, and therefore the propagation characteristics of radio waves can be measured accurately and easily at an arbitrary position in the three-dimensional space.

For example, in the propagation characteristic measurement system 1, the measuring device 5 continuously measures the position of the mobile station 4, and the fixed station 2 acquires reception signal information in synchronization with the measurement of the measuring device 5, and therefore it is also possible to continuously measure the propagation characteristics of radio waves at arbitrary positions in the three-dimensional space.

The embodiments described above are given as examples of embodiments of the present invention, rather than limiting the present invention, and the present invention can also be implemented in various other variations and modified embodiments.

### REFERENCE SIGNS LIST

1, 1a Propagation characteristic measurement system

2 Fixed station

3 Unmanned aerial vehicle

4, 4a Mobile station.

5 Measuring device

6 Structure

20, 40, 40a Antenna

21 Reception unit

22 Control unit

23 Acquisition unit

24 Communication unit

25 Calculation unit

30 Propeller

42 Prism

44 Control unit

46 Transmission unit

50 Lens

52 Measurement unit

56 Position acquisition unit

56 Communication unit

58 Control unit

1. A propagation characteristic measurement system comprising:
a first wireless station;
a second wireless station configured to be capable of moving to an arbitrary position in a three-dimensional space, and configured to perform wireless communication with the first wireless station; and
a measuring device configured to measure a position of the second wireless station in the three-dimensional space to obtain measurement information,
wherein at least one out of the first wireless station, the second wireless station, and the measuring device includes
an acquisition unit configured to acquire reception signal information that was received by the first wireless station or the second wireless station, and
a calculation unit configured to associate the measurement information and the reception signal information with each other and calculate a propagation characteristic between the first wireless station and the second wireless station.

2. The propagation characteristic measurement system according to claim 1, further comprising:
a control unit configured to perform control to synchronize the time when the measuring device measures the position of the second wireless station and the time when the first wireless station or the second wireless station receives the reception signal information,
wherein the calculation unit associates the measurement information and the reception signal information with each other based on the time synchronized by the control unit.

3. The propagation characteristic measurement system according to claim 1,
wherein the second wireless station includes an antenna configured to transmit and receive radio waves, the antenna being provided at a location where a line of sight to an antenna provided in the first wireless station is not obstructed.

4. The propagation characteristic measurement system according to claim 1,
wherein the measuring device tracks the second wireless station by irradiating a prism provided in the second wireless station with light while measuring the position of the second wireless station in the three-dimensional space.

5. A propagation characteristic measurement method for measuring a propagation characteristic between a first wireless station and a second wireless station that can move to an arbitrary position in a three-dimensional space and performs wireless communication with the first wireless station, the propagation characteristic measurement method comprising:
a measuring step of measuring a position of the second wireless station in the three-dimensional space to obtain measurement information;
an acquiring step of acquiring reception signal information that was received by the first wireless station or the second wireless station; and
a calculating step of associating the measurement information and the reception signal information with each other and calculating a propagation characteristic between the first wireless station and the second wireless station.

6. The propagation characteristic measurement method according to claim 5, further comprising:
a controlling step of performing control to synchronize the time when the position of the second wireless station is measured and the time when the first wireless station or the second wireless station receives the reception signal information,
wherein in the calculating step, the measurement information and the reception signal information are associated with each other based on the time synchronized in the controlling step.

7. The propagation characteristic measurement method according to claim 5,
wherein the second wireless station includes an antenna configured to transmit and receive radio waves, the antenna being provided at a location where a line of sight to an antenna provided in the first wireless station is not obstructed.

8. The propagation characteristic measurement method according to claim 5,
wherein in the measuring step, a measuring device tracks the second wireless station by irradiating a prism provided in the second wireless station with light while measuring the position of the second wireless station in the three-dimensional space.
